(19) United States
(12) Patent Application Publication
(10) Pub. No.: US 2002/0009549 A1
(43) Pub. Date: Jan. 24, 2002

(54) Slide-bead coating method with coating liquids containing polyvinyl alcohol

(76) Inventor: Shotaro Ogawa, Fujinomiya-shi (JP)

Correspondence Address: Sughrue Mion Zinn Macpeak & Seas, 2100 Pennsylvania Avenue N W, Washington, DC, 20037, US

(21) Appl. No.: 09/531,171

(22) Filed: Mar. 21, 2000

(30) Foreign Application Priority Data
Mar. 23, 1999 (JP) 11-078538
Mar. 23, 1999 (JP) 11-078540

(51) Int. Cl. B05D 1/30; B05D 1/36; B05C 3/02

(52) U.S. Cl. 427/402; 427/420; 118/410; 118/411

(57) ABSTRACT

To stably coat a surface of a web with multiple coating liquids containing polyvinyl alcohol (PVA) to simultaneously form multiple layers on the surface of the web by means of a slide-hopper coating apparatus, a polymerization degree of PVA contained in one of the coating liquids forming the bottom layer among the multiple layers is within the range between 1000 and 4000, and a density of PVA contained in the coating liquid forming the bottom layer is at most 4% by weight, and a viscosity of at least one of the coating liquids that forms one of the layers other than the bottom layer is higher than a viscosity of the coating liquid forming the bottom layer. Alternatively, the polymerization degree of PVA contained in the coating liquid forming the bottom layer is within the range between 1000 and 4000, and an additive used to increase viscosity is added to the coating liquid forming the bottom layer within the range between 0.05% and 0.5% by weight with respect to an amount of PVA contained in the coating liquid forming the bottom layer.

### BACKGROUND OF THE INVENTION

1. Field of the Invention

The present invention relates generally to a slide-bead coating method with coating liquids containing polyvinyl alcohol (PVA), and more particularly to a slide-bead coating method with PVA coating liquids for coating a continuously-running web with multiple PVA coating liquids to precisely form multiple layers on the web in the manufacture of heat-sensitive recording paper, pressure-sensitive recording paper, printing plates, and the like.

2. Description of Related Art

A slide-hopper coating apparatus is an apparatus for coating a continuously-running web with coating liquids, and it is used for coating the web with multiple coating liquids containing PVA (hereinafter referred to as PVA coating liquids) with a uniform thickness without unevenness.

In a slide-bead coating method using the slide-hopper coating apparatus, the multiple coating liquids flow down along a slide surface, and a bead part is formed at the gap between the end of the slide surface and the continuously-running web where the coating liquids meet the web. The surface of the web is coated with the coating liquids through the bead part.

In the case of the PVA coating liquids, however, the flow of the PVA coating liquids becomes unstable due to the characteristics of the PVA coating liquids since the PVA coating liquids are rapidly expanded at the bead part when a coating speed (a running speed of the web) is high. Consequently, serious coating defects such as streak-shaped unevenness and air entrainment occur in the multiple layers on the surface of the web. This is because the flow of the PVA coating liquids becomes more unstable than that of ordinary coating liquids due to the compulsory expansion in case of the coating liquids such as the PVA coating liquids that contain a lot of high polymers. In the slide-bead coating method, however, streaks are formed in the running direction of the web when the densities of PVA contained in the PVA coating liquids are too low, since the viscosities of the PVA coating liquids become low and the flow is rapidly accelerated.

Thus, the coating speed conventionally has to be 100 m/min or less in the slide-bead coating method with the PVA coating liquids, and the coating efficiency is low as a result. A slide-bead coating method where no coating defect occurs even when the coating speed is high is desired, and a variety of measures have been taken.

Japanese Patent Provisional Publication No. 5-323116 discloses that the viscosity of the bottom layer is low and the viscosity of the top layer is high in the multi-layer coating of polarization film containing organic coloring chemicals. Japanese Patent Provisional Publication No. 7-18599 discloses that paper is coated with the PVA coating liquid whose density is within the range between 12% and 60% at the coating speed of 200 m/min or more when the coating temperature is within the range between 60° C. and 95° C. and the viscosity of the PVA coating liquid is within the range between 100 cP and 3000 cP. Japanese Patent Provisional Publication No. 6-294099 discloses that printing paper mainly composed of pigments is curtain-coated with the PVA coating liquid whose density is within the range between 0.5% and 2.5%.

Japanese Patent Publication No. 56-20534 discloses that the viscosity and the coating amount of the PVA coating liquid for the bottom layer are low and the viscosity and the coating amount of the PVA coating liquid for the next layer are high. Japanese Patent Provisional Publication No. 57-99367 discloses that a layer whose viscosity is low is formed below a layer whose viscosity is high. Japanese Patent Provisional Publication No. 2-83066 discloses that the viscosity of the coating liquid for the bottom layer is adjusted in accordance with the density of insoluble solids in the coating liquid. Japanese Patent Provisional Publication No. 56-108566 discloses that the viscosity of the bottom layer is lower than that of the next layer in a high shearing area and is higher than that of the next layer in a low shearing area. Japanese Patent Provisional Publication No. 9-108615 discloses that the range of the shearing viscosity and the range of the expansion viscosity of at least one layer are determined.

Above-described conventional coating techniques using the PVA coating liquid and the techniques related to the multi-layer coating methods prevent the coating defects by basically making the viscosity of the bottom layer low and the viscosity of the next layer high.

Another reason why the coating defects occur in the multiple layers of the PVA coating liquids is that the PVA coating liquids Newtonian-flow, and an additive used to increase viscosity is added to the PVA coating liquids to give non-Newtonian viscosity (characteristics that lower the viscosity at a high shearing) to the PVA coating liquids in order to adapt the PVA coating liquids to the high speed coating. Japanese Patent Provisional Publication No. 6-81297 discloses that paper is coated with the PVA coating liquids to which carboxymethyl starch, water soluble cellulose compound and marine algae polysaccharide are added.

When the coating speed is high at approximately 200 m/min, however, the coating defects can not be prevented enough even if the techniques that determine the viscosities of the bottom layer and the next layer and the techniques that add the additive used to increase viscosity to the PVA coating liquids are combined. When the additive used to increase viscosity is added to the PVA coating liquids, the added additive used to increase viscosity does not enable the high speed coating by itself, and it may have harmful effects on the high speed coating when the adding conditions of the additive used to increase viscosity is incorrect.

### SUMMARY OF THE INVENTION

In view of the foregoing, it is an object of the present invention to provide a slide-bead coating method with PVA coating liquids, where coating defects (streak-shaped unevenness and air entrainment) do not occur even when a coating speed is high.

To achieve the above-mentioned object, the present invention is directed to a slide-bead coating method where a slide-hopper coating apparatus coats a surface of a running web with a plurality of coating liquids containing polyvinyl alcohol to simultaneously form a plurality of layers on the surface of the running web, wherein: a polymerization degree of polyvinyl alcohol contained in one of the coating liquids that forms a bottom layer among the layers is within a range between 1000 and 4000; a density of polyvinyl alcohol contained in the one of the coating liquids that forms the bottom layer is at most 4% by weight; and a viscosity of at least one of the coating liquids that forms one of the layers other than the bottom layer is higher than a viscosity of the one of the coating liquids that forms the bottom layer.

Preferably, a coating amount of the one of the coating liquids that forms the bottom layer with respect to the running web is within a range between 2 cm³/m² and 15 cm³/m².

Preferably, an additive used to increase viscosity is added to one of the coating liquids.

To achieve the above-mentioned object, the present invention is also directed to a slide-bead coating method where a slide-hopper coating apparatus coats a surface of a running web with a plurality of coating liquids containing polyvinyl alcohol to simultaneously form a plurality of layers on the surface of the running web, wherein: a polymerization degree of polyvinyl alcohol contained in one of the coating liquids that forms a bottom layer among the layers is within a range between 1000 and 4000; and an additive used to increase viscosity is added to the one of the coating liquids that forms the bottom layer within a range between 0.05% and 0.5% by weight with respect to an amount of polyvinyl alcohol contained in the one of the coating liquids that forms the bottom layer.

Preferably, a density of polyvinyl alcohol contained in the one of the coating liquids that forms the bottom layer is within a range between 0.5% and 5% by weight.

Preferably, a viscosity of at least one of the coating liquids that forms one of the layers other than the bottom layer is higher than a viscosity of the one of the coating liquids that forms the bottom layer.

Preferably, the additive used to increase viscosity comprises water-soluble cellulose.

According to the present invention, the coating defects (streak-shaped unevenness and air entrainment) can be prevented even when the coating speed is high, for example, within a range between 100 m/min and 300 m/min.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is an explanation drawing showing the structure of a slide-hopper coating apparatus to which a slide-bead coating method according to the present invention is applied; and

FIG. 2 is a structural drawing in the case where corona discharge treatment is applied to a web.

### DETAILED DESCRIPTION OF THE PREFERRED EMBODIMENT

This invention will be described in further detail by way of example with reference to the accompanying drawings.

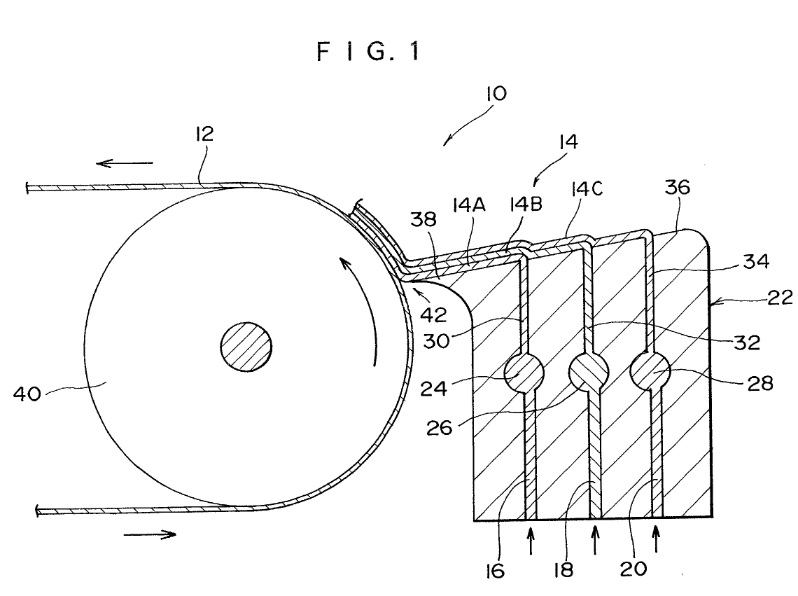

FIG. 1 is an explanation drawing showing the structure of a slide-hopper coating apparatus 10 to which a slide-bead coating method according to the present invention is applied, and three layers are simultaneously formed on a web 12.

As shown in FIG. 1, multiple types (e.g., three types) of coating liquids 14 to be applied on the surface of the web 12 are supplied to manifolds 24, 26, 28 in a slide hopper 22 through supply lines 16, 18, 20, respectively. The PVA coating liquids 14 supplied to the manifolds 24, 26, 28 are expanded in a coating width direction, and then they flow onto an inclined slide surface 36 through slit-shaped slots 30, 32, 34, respectively. The PVA coating liquids 14 flowing on the slide surface 36 form multiple layers without mixing with one another to flow along the slide surface 36, and reach a lip end 38 that is the bottom end of the slide surface 36. The PVA coating liquids 14 that reach the lip end 38 form a bead part 42 at the gap between the lip end 38 and the surface of the web 12 running while being wound on a backing roller 40. At the bead part 42, the web 12 runs upward along the surface of the backing roller 40. Thus, the PVA coating liquids 14 are pulled onto the surface of the web 12 and expanded to become thinner. Consequently, the thin multiple layers are formed on the surface of the running web 12. The thickness of the multiple layers depends on the running speed of the web 12. In FIG. 1, the reference numeral 14A denotes the PVA coating liquid that forms the bottom layer of the multiple layers, and the reference numeral 14B denotes the PVA coating liquid that forms the middle layer, and the reference numeral 14C denotes the PVA coating liquid that forms the top layer.

In the case of slide-bead coating with the PVA coating liquids 14, which contain PVA, however, the flow of the PVA coating liquids 14 becomes unstable due to the characteristics of the PVA coating liquids 14 since the PVA coating liquids 14 are rapidly expanded at the bead part 42 when the coating speed is high, and thus serious coating defects such as streak-shaped unevenness and air entrainment occur.

The present inventor has found out coating conditions where the coating defects do not occur even if the coating speed is high, by examining factors of the coating defects at the high speed coating and measures.

(1) When the density of PVA contained in the PVA coating liquids 14 is too high, the coating defects occur even if the viscosity of the PVA coating liquid 14A that forms the bottom layer of the multiple layers is low. To prevent the coating defects, the viscosity of the PVA coating liquid 14A that forms the bottom layer is lowered and the density of PVA contained in the PVA coating liquid 14A that forms the bottom layer is 4% or less, so that the air entrainment due to the unstable flow at the bead part 42 can be prevented.

(2) However, when the viscosity of the PVA coating liquid 14A that forms the bottom layer is too low, streaks are formed in the running direction of the web 12. To prevent the streaks, the polymerization degree of PVA contained in the PVA coating liquid 14A that forms the bottom layer is within the range between 1000 and 4000, preferably within the range between 1500 and 3000. In this case, the streaks can not be prevented when the polymerization degree of PVA is less than 1000, and it is difficult to dissolve PVA and it is not suitable for practical use when the polymerization degree of PVA is more than 4000.

(3) The viscosities of the PVA coating liquid 14A that forms the bottom layer and the PVA coating liquids 14B and 14C that form the middle and the top layers are determined to prevent the coating defects. At least one of the viscosities of the PVA coating liquids 14B and 14C is higher than the viscosity of the PVA coating liquid 14A that forms the bottom layer, so that the streak-shaped unevenness can be prevented.

(4) By combining (1) (2) and (3), the coating defects can be prevented when the surface of the web 12 is coated with the PVA coating liquids 14 at a high speed. If the coating amount of the PVA coating liquid 14A that forms the bottom layer is too small, the air entrainment can not be prevented. To address this problem, the coating amount of the PVA coating liquid 14A is within the range between 2 cm³/m² and 15 cm³/m², preferably within the range between 3 cm³/m² and 10 cm³/m².

The slide-bead coating method with the PVA coating liquids according to the present invention is based on the above-described conditions. In the slide-bead coating method with the PVA coating liquids, the slide-hopper coating apparatus 10 coats the running web 12 with the multiple PVA coating liquids 14 containing PVA to simultaneously form the multiple layers on the surface of the web 12, and the polymerization degree of PVA contained in the PVA coating liquid 14A that forms the bottom layer is within the range between 1000 and 4000 and the density of PVA contained in the PVA coating liquid 14A is 4% or less and at least one of the viscosities of the PVA coating liquids 14B and 14C is higher than the viscosity of the PVA coating liquid 14A. The coating amount of the PVA coating liquid 14A with respect to the web 12 is within the range between 2 cm³/m² and 15 cm³/m².

Therefore, the web 12 can be coated in the slide-bead coating method with the PVA coating liquids 14 containing PVA at a high coating speed without the coating defects such as the streak-shaped unevenness and the air entrainment. The coating speed is within the range between 100 and 300 m/min, preferably within the range between 180 and 300 m/min. Even in the case of a PVA coating liquid whose density and the viscosity are high that is difficult to coat the web 12 with, the web 12 can be stably coated and the drying load can be reduced by using a PVA coating liquid that satisfies the coating conditions of the present invention for the bottom layer.

PVA used in the present invention is polyvinyl alcohol polymer. PVA is used as a binder in the case of chemical coating, and is used for maintaining barrier and surface strength, and the like. PVA is generated by saponifying vinylester such as vinyl acetate or vinylester that is generated by polymerizing in a polymerizing method such as bulk polymerization, emulsion polymerization, solution polymerization and suspension polymerization or copolymerizing vinylester with copolymerized monomer. The saponification rate of PVA is within the range between 60% and 100%, preferably within the range between 70% and 99.5%, more preferably within the range between 80% and 99.5%.

In this invention, an additive used to increase viscosity is preferably added to the PVA coating liquids 14 to further prevent the coating defects when the coating speed is high. In this case, if the polymerization degree of PVA is too low, the rise in the viscosity by the additive used to increase viscosity is small and the effect of the added additive used to increase viscosity is small. Thus, the polymerization degree of PVA contained in the PVA coating liquids 14 is preferably within the range between 1000 and 4000.

The additive used to increase viscosity may be water soluble cellulose compound, marine algae polysaccharide, carboxymethyl starch or the like, preferably water soluble cellulose compound. Thus, the multiple layers can be kept stable by rising the viscosity of the multiple layers at a low shearing when they flow along the slide surface 36 while maintaining the viscosity of the multiple layers at a high shearing at the bead part 42. The adding amount of the additive used to increase viscosity is determined in accordance with the coating amount and the coating speed of the web 12, and it is within the range between 0.05% and 0.5% by weight with respect to PVA of the PVA coating liquids 14, preferably within the range between 0.06% and 0.4% by weight, more preferably within the range between 0.1% and 0.35% by weight. The effect of the added additive used to increase viscosity is small if the adding amount of the additive used to increase viscosity is too small, and the viscosity of the PVA coating liquids 14 becomes to high to cause the coating defects if the adding amount of the additive used to increase viscosity is too high.

The web 12 used in the present invention may be made of paper, resin film such as polyethylene film, metal foil, or the like, preferably resin film.

In the present invention, surface treatment that is corona treatment or electrification treatment is applied to the web 12 just before the surface of the web 12 is coated with the PVA coating liquids 14.

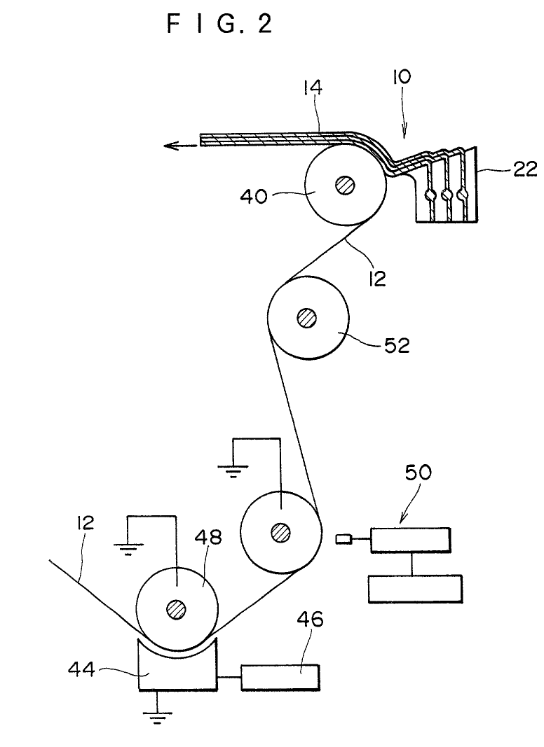

FIG. 2 is a structural drawing in the case where corona discharge treatment is applied to the web 12. As shown in FIG. 2, a high voltage is applied from a high-voltage power supply 46 to a web electrification apparatus 44 provided before the slide-hopper coating apparatus 10 and corona discharge is applied to the web 12 that runs while being wound on a grounded support roller 48. Thus, a single-pole electric charge is given to the surface of the web 12. Then, the web 12 passes a surface-potential meter 50, which measures the potential of the surface of the web 12 and records the potential in a recorder. The web 12 that has passed the surface-potential meter 50 reaches the backing roller 40 of the slide-hopper coating apparatus 10 through a pass roller 52, and is coated with the PVA coating liquids 14 from the slide hopper 22.

As described above, the single-pole electric charge is given to the surface of the web 12 at the web electrification apparatus 44, so that the affinity and the adhesion of the web 12 and the PVA coating liquids 14 can be improved to improve the coating efficiency.

To prevent the coating defects, an additive used to increase viscosity may be added to the PVA coating liquids 14, but it can not enable the high speed coating by itself.

The present inventor has found out adding conditions of the additive used to increase viscosity where the coating defects do not occur even if the coating speed is 200 m/min or more.

(1) It is important to determine the adding amount of the additive used to increase viscosity to the PVA coating liquid 14A that forms the bottom layer not in accordance with the amount of the PVA coating liquids 14 but the amount of PVA contained in the PVA coating liquids 14 for the stable high speed coating. The adding amount of the additive used to increase viscosity is within the range between 0.05% and 0.5% by weight with respect to PVA, preferably within the range between 0.06% and 0.4% by weight, more preferably within the range between 0.1% and 0.35% by weight. The effect of the added additive used to increase viscosity is small if the adding amount of the additive used to increase viscosity is less than 0.05% by weight, and the viscosity of the PVA coating liquids 14 becomes too high to cause the coating defects if the adding amount of the additive used to increase viscosity is more than 0.5% by weight.

(2) The polymerization degree of PVA is also important to make the added additive used to increase viscosity effective. The polymerization degree of PVA is within the range between 1000 and 4000, preferably within the range between 1500 and 3000. The rise in the viscosity by the additive used to increase viscosity is small and the effect of the added additive used to increase viscosity is small when the polymerization degree of PVA is less than 1000, and it is difficult to dissolve PVA and it is not suitable for practical use when the polymerization degree of PVA is more than 4000.

(3) The viscosities of the PVA coating liquid 14A that forms the bottom layer and the PVA coating liquid 14B that forms the middle layer are determined to prevent the coating defects. The viscosity of the PVA coating liquid 14B that forms the middle layer is higher than the viscosity of the PVA coating liquid 14A that forms the bottom layer, so that the streak-shaped unevenness can be prevented.

(4) However, if the density of PVA contained in the PVA coating liquid 14A that forms the bottom layer is too high, the coating defects occur even if the viscosity of the PVA coating liquid 14A that forms the bottom layer is smaller than the viscosity of the PVA coating liquid 14B that forms the middle layer. To prevent the coating defects, the density of PVA contained in the PVA coating liquid 14A is within the range between 0.5% and 5% when the additive used to increase viscosity is added to the PVA coating liquid 14A that forms the bottom layer.

The slide-bead coating method with the PVA coating liquids according to the present invention determines the adding amount of the additive used to increase viscosity to the PVA coating liquid 14A that forms the bottom layer, and so on, on the basis of the above-described conditions. In the slide-bead coating method with the PVA coating liquids, the slide-hopper coating apparatus 10 coats the running web 12 with the multiple PVA coating liquids 14 containing PVA to simultaneously form the multiple layers on the surface of the web 12, and the polymerization degree of PVA contained in the PVA coating liquid 14A that forms the bottom layer is within the range between 1000 and 4000 and the additive used to increase viscosity is added to the PVA coating liquid 14A in such a manner that the adding amount of the additive used to increase viscosity can be within the range between 0.05% and 0.5% by weight with respect to the amount of PVA. The density of PVA contained in the PVA coating liquid 14A is within the range between 0.5% and 5%.

Thus, the multiple layers can be kept stable by rising the viscosity of the multiple layers at a low shearing when they flow along the slide surface 36 while maintaining the viscosity of the multiple layers at a high shearing at the bead part 42. Therefore, the web 12 can be coated with the PVA coating liquids 14 with a uniform thickness without unevenness even if the coating speed is high.

### EXAMPLES

Then, the explanation will now be given of examples according to the present invention and comparative examples where two layers were simultaneously formed on the web 12 on the conditions in Table 1 by means of the slide-hopper coating apparatus described in the embodiment. The surface treatment was not applied to the web 12.

Examples (1)-(4) satisfied the conditions of the slide-bead coating method according to the present invention, while comparative examples (1)-(5) did not satisfy the conditions. The types, the densities, the viscosities and the coating amounts of the PVA coating liquids that form the bottom and the top layers are shown in Table 2. The densities in Table 2 were densities of PVA in the PVA coating liquids by weight, and the viscosities were values when the shearing speed was 50 (1/sec). The coating amounts were values in liquid-state.

With respect to the examples (1)-(4) and the comparative examples (1)-(5), limit speeds at which coating defects started to occur were examined when only the coating speed were raised on the same coating temperature, the same operation conditions and the same web condition. Also, which of the coating defects, streak-shaped unevenness or air entrainment, occurred at the limit speeds were examined.

TABLE 1

| Items | Coating conditions | |
|---|---|---|
| Coating | 25° C. (temperatures of PVA coating liquids were the | |
| temperature | same) | |
| Operation | Bead pressure | 30 mm H₂O |
| conditions | Bead gap | 0.2 mm |
| | Slide angle | 20° |

| | |
|---|---|
| Web | PET film with thickness of 0.1 mm |
| Types of PVA | |
| coating | |
| liquids | |
| (a) | Solution containing PVA217 (P = 1700), heat sensitizing |
| | agent and pigment |
| (b) | Solution containing PVA124 (P = 2400), heat sensitizing |
| | agent and pigment |
| (c) | Solution containing PVA205 (P = 500), heat sensitizing |
| | agent and pigment |
| (d) | Solution containing PVA103 (P = 300), heat sensitizing |
| | agent and pigment |

Notes in Table 1:
(i) The bead gap is the gap between the end of the slide hopper and the web.
(ii) The slide angle is the inclining angle of the slide surface with respect to the horizontal plane.
(iii) Every type of PVA was made by Kuraray Co., Ltd.
(iv) The densities of PVA coating liquids (a) and (c) were adjusted by adding water.
(v) Each P of the PVA coating liquid indicates the polymerization degree of PVA contained in the PVA coating liquid.

TABLE 2

| | Bottom layer | | | | Top layer | | | | | |
|---|---|---|---|---|---|---|---|---|---|---|
| | | Den- | Vis- | Coating | | Den- | Vis- | Coating | Limit | Coating |
| | | sity | cosity | amount | | sity | cosity | amount | speed | defect at limit |
| | Type | [%] | [cP] | [cm³/m²] | Type | [%] | [cP] | [cm³/m²] | [m/min] | speed |
| Ex. (1) | (a) | 3 | 22 | 8 | (a) | 6 | 56 | 40 | 300 | Streak-shaped |
| | | | | | | | | | | unevenness |
| | | | | | | | | | | Air |
| Ex. (2) | (a) | 4 | 28 | 6 | (a) | 8 | 88 | 64 | 240 | entrainment |
| | | | | | | | | | | Air |
| Ex. (3) | (b) | 3 | 30 | 3 | (a) | 7 | 72 | 57 | 220 | entrainment |
| | | | | | | | | | | Air |
| Ex. (4) | (a) | 4 | 28 | 1 | (c) | 12 | 43 | 50 | 180 | entrainment |
| Comp. | (a) | 5 | 45 | 6 | (a) | 7 | 72 | 54 | 120 | Air |
| Ex. (1) | | | | | | | | | | entrainment |
| Comp. | (a) | 3 | 22 | 6 | (c) | 4 | 16 | 54 | 100 | Streak-shaped |
| Ex. 2 | | | | | | | | | | unevenness |
| Comp. | (c) | 4 | 16 | 6 | (c) | 6 | 28 | 54 | 90 | Streak-shaped |
| Ex. (3) | | | | | | | | | | unevenness |
| Comp. | (a) | 3 | 22 | 2 | (a) | 7 | 72 | 58 | 140 | Air |
| Ex. (4) | | | | | | | | | | entrainment |
| Comp. | (d) | 3 | 24 | 4 | (a) | 7 | 72 | 56 | 110 | Air |
| Ex. (5) | | | | | | | | | | entrainment |

As shown in Table 2, the limit speeds, at which the coating defects started to occur, of the comparative examples (1)-(5), which did not satisfy the conditions of the slide-bead coating method according to the present invention, were within the range of 90 m/min and 140 m/min.

Meanwhile, the limit speeds of the examples (1)-(4), which satisfied the conditions of the slide-bead coating method according to the present invention, were within the range of 180 m/min and 300 m/min.

The examples according to the present invention restrained streak-shaped unevenness and air entrainment compared with the comparative examples, and the limit speeds, at which the coating defects started to occur, of the examples were roughly twice those of the comparative examples.

In the examples (1) and (2), where the PVA coating liquid (a) was used for the bottom layer and the densities of PVA were 3% and 4%, the limit speeds were 300 m/min and 240 m/min, respectively. On the other hand, the limit speed of the comparative example (1), where the PVA coating liquid (a) was used for the bottom layer likewise the example (1) and the density of PVA was 5%, was 120 m/min.

The limit speed of the example (3), where the PVA coating liquid (b) was used in stead of the PVA coating liquid (a) used in the example (1) for the bottom layer and the density of PVA was 3%, was 220 m/min, higher than those of the comparative examples. The limit speed of the example (4), where the density of PVA of the top layer was extremely high and the density of PVA of the bottom layer was 4%, was 180 m/min, higher than those of the comparative examples. The density of PVA of the bottom layer affected more on the limit speed than the viscosity of PVA coating liquid for the bottom layer.

Meanwhile, the limit speeds of the comparative example (2), where the viscosity of the top layer was lower than that of the bottom layer, and the comparative examples (3) and (5), where the polymerization degrees of PVA of the bottom layer were low, were within the range of 90 m/min and 110 m/min though the density of PVA of the bottom layer were low. The limit speed of the comparative example (4), where the coating amount of the bottom layer was low though the polymerization degree of PVA of the bottom layer was high, was low.

Then, the explanation will now be given of examples according to the present invention and comparative examples where two layers were simultaneously formed on the web 12 on the conditions in Table 1 by means of the slide-hopper coating apparatus described in the embodiment. The surface treatment was not applied to the web 12.

Examples (5)-(7) satisfied the conditions of the slide-bead coating method according to the present invention, while comparative examples (6)-(11) did not satisfy the conditions. The types, the densities and the viscosities of the PVA coating liquids that form the bottom and the top layers and the adding amount of the additive used to increase viscosity to the top layer are shown in Table 3. The densities in Table 3 were densities of PVA in the PVA coating liquids by weight, and the viscosities were values when the shearing speed was 50 [1/sec]. The coating amounts were values in liquid-state. The additive used to increase viscosity was water-soluble cellulose, and the adding amount was indicated with respect to the amount of PVA by weight.

With respect to the examples (5)-(7) and the comparative examples (6)-(11), limit speeds at which coating defects started to occur were examined when only the coating speed were raised on the same coating temperature, the same operation conditions and the same web condition. Also, which of the coating defects, streak-shaped unevenness or air entrainment, occurred at the limit speeds were examined.

TABLE 3

| | Bottom layer | | | | Top layer | | | | |
|---|---|---|---|---|---|---|---|---|---|
| | | Den- | Vis- | Adding amount of | | Den- | Vis- | Limit | |
| | | sity | cosity | additive used, to in- | | sity | cosity | speed | Coating defect |
| | Type | [%] | [cP] | crease viscosity [%] | Type | [%] | [cP] | [m/min] | at limit speed |
| Ex. (5) | (a) | 3.0 | 45 | 0.3 | (a) | 6.0 | 90 | 300 | Air |
| | | | | | | | | | entrainment |
| Ex. (6) | (a) | 5.0 | 70 | 0.1 | (a) | 6.0 | 90 | 240 | Air |
| | | | | | | | | | entrainment |
| Ex. (7) | (b) | 3.0 | 60 | 0.2 | (a) | 6.0 | 90 | 220 | Air |
| | | | | | | | | | entrainment |
| Comp. | (a) | 3.0 | 45 | 0 | (a) | 6.0 | 90 | 120 | Streak-shaped |
| Ex. (6) | | | | | | | | | unevenness |
| Comp. | (c) | 4.5 | 22 | 0.3 | (a) | 6.0 | 90 | 100 | Streak-shaped |
| Ex. (7) | | | | | | | | | unevenness |
| Comp. | (d) | 8.0 | 16 | 0.5 | (a) | 6.0 | 90 | 90 | Air |
| Ex. (8) | | | | | | | | | entrainment |
| Comp. | (a) | 3.0 | 22 | 0.04 | (a) | 6.0 | 90 | 140 | Streak-shaped |
| Ex. (9) | | | | | | | | | unevenness |
| Comp. | (b) | 3.0 | 24 | 0.04 | (a) | 6.0 | 90 | 110 | Streak-shaped |
| Ex. (10) | | | | | | | | | unevenness |
| Comp. | (a) | 3.0 | 24 | 0.6 | (a) | 6.0 | 90 | 110 | Air |
| Ex. (11) | | | | | | | | | entrainment |

As shown in Table 3, the limit speeds, at which the coating defects started to occur, of the comparative examples (6)-(11), which did not satisfy the conditions of the slide-bead coating method according to the present invention, were within the range of 100 m/min and 180 m/min.

Meanwhile, the limit speeds of the examples (5)-(7), which satisfied the conditions of the slide-bead coating method according to the present invention, were within the range of 220 m/min and 300 m/min, and thus the coating defects did not occur when the limit speeds were more than 200 m/min.

The examples according to the present invention restrained streak-shaped unevenness and air entrainment compared with the comparative examples, and the limit speeds, at which the coating defects started to occur, of the examples were higher than those of the comparative examples.

In the comparative example (6), where the additive used to increase viscosity was not added to the PVA coating liquid forming the bottom layer, the limit speed was 120 m/min. On the other hand, the limit speed of the example (5), where the adding amount of the additive used to increase viscosity was 0.3% and the other conditions were almost the same as the comparative example (6), was 300 m/min, more than twice that of the comparative example (6).

The limit speeds of the comparative examples (7) and (8), where the adding amount of the additive used to increase viscosity with respect to the amount of PVA were 0.3% and 0.5%, were 100 m/min and 120 m/min, respectively, since the polymerization degrees of PVA of the bottom layer were low. On the other hand, the limit speeds of the examples (5)-(7), where the polymerization degrees of PVA of the bottom layer were high, were within the range between 220 m/min and 300 m/min.

The limit speeds of the comparative examples (9) and (10) were 140 m/min and 180 m/min, respectively, since the adding amount of the additive used to increase viscosity were 0.04%, less than 0.05%, though the polymerization degrees of PVA were high. On the other hand, the limit speed of the comparative example (11) was 160 m/min since the adding amount of the additive used to increase viscosity was 0.6%, more than 0.5%. However, the limit speed of the comparative example (11) was higher than those of the comparative examples (6)-(8), within the range between 100 m/min and 120 m/min. This was because the polymerization degree of PVA for the bottom layer was high though the adding amount of the additive used to increase viscosity with respect to the amount of PVA was a little out of the range between 0.05% and 0.5% by weight. This was why the limit speed of the comparative example (11) where the polymerization degree of PVA for the bottom layer was the highest among those of the comparative examples (9)-(11) was 180 m/min, close to the limit speeds of the examples (1)-(3).

Therefore, it is important to appropriately determine the polymerization degree of PVA for the bottom layer and the adding amount of the additive used to increase viscosity with respect to the amount of PVA in order to raise the limit speed.

As set forth hereinabove, according to the slide-bead coating method with the PVA coating liquids of the present invention, the coating defects (the streak-shaped unevenness and the air entrainment) can be prevented even when the coating speed is high. The coating defects do not occur even when the coating speed is 200 m/min or more in the slide-bead coating method of the present invention, while the conventional coating speed is approximately 100 m/min.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A slide-bead coating method where a slide-hopper coating apparatus coats a surface of a running web with a plurality of coating liquids containing polyvinyl alcohol to simultaneously form a plurality of layers on the surface of the running web, wherein:
a polymerization degree of polyvinyl alcohol contained in one of the coating liquids that forms a bottom layer among the layers is within a range between 1000 and 4000;
a density of polyvinyl alcohol contained in the one of the coating liquids that forms the bottom layer is at most 4% by weight; and
a viscosity of at least one of the coating liquids that forms one of the layers other than the bottom layer is higher than a viscosity of the one of the coating liquids that forms the bottom layer.

2. The slide-bead coating method as defined in claim 1, wherein a coating amount of the one of the coating liquids that forms the bottom layer with respect to the running web is within a range between 2 cm³/m² and 15 cm³/m².

3. The slide-bead coating method as defined in claim 1, wherein a coating speed that is a running speed of the running web is within a range between 100 m/min and 300 m/min.

4. The slide-bead coating method as defined in claim 1, wherein an additive used to increase viscosity is added to one of the coating liquids.

5. The slide-bead coating method as defined in claim 1, wherein surface treatment by one of corona treatment and electrification treatment is applied to the running web before the surface of the running web is coated with the coating liquids.

6. A slide-bead coating method where a slide-hopper coating apparatus coats a surface of a running web with a plurality of coating liquids containing polyvinyl alcohol to simultaneously form a plurality of layers on the surface of the running web, wherein:
a polymerization degree of polyvinyl alcohol contained in one of the coating liquids that forms a bottom layer among the layers is within a range between 1000 and 4000; and
an additive used to increase viscosity is added to the one of the coating liquids that forms the bottom layer within a range between 0.05% and 0.5% by weight with respect to an amount of polyvinyl alcohol contained in the one of the coating liquids that forms the bottom layer.

7. The slide-bead coating method as defined in claim 6, wherein a density of polyvinyl alcohol contained in the one of the coating liquids that forms the bottom layer is within a range between 0.5% and 5% by weight.

8. The slide-bead coating method as defined in claim 6, wherein a viscosity of at least one of the coating liquids that forms one of the layers other than the bottom layer is higher than a viscosity of the one of the coating liquids that forms the bottom layer.

9. The slide-bead coating method as defined in claim 6, wherein the additive used to increase viscosity comprises water-soluble cellulose.

10. The slide-bead coating method as defined in claim 6, wherein the running web comprises resin film.

11. The slice-bead coating method as defined in claim 6, wherein a coating speed that is a running speed of the running web is within a range between 100 m/min and 300 m/min.

12. The slide-bead coating method as defined in claim 6, wherein surface treatment by one of corona treatment and electrification treatment is applied to the running web before the surface of the running web is coated with the coating liquids.
